(19) United States
(12) Patent Application Publication
(10) Pub. No.: US 2009/0086286 A1
(43) Pub. Date: Apr. 2, 2009

(54) IMAGE READING APPARATUS AND IMAGE FORMING APPARATUS

(75) Inventor: Yuki Tojo, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/211,246

(22) Filed: Sep. 16, 2008

(30) Foreign Application Priority Data
Sep. 27, 2007 (JP) 2007-252485

(51) Int. Cl. H04N 1/04

(52) U.S. Cl. 358/488

(57) ABSTRACT

During a document reading operation in a double-sided reverse-reading mode, a controller controls a document feeding section to convey a document at a predetermined speed which is faster than a predetermined document reading speed at which a CIS can read the document when the document passes through the document reading position of the CIS. When the document passes through the document reading position of the CCD, the controller controls the document feeding section to convey the document at a predetermined document reading speed at which the CCD can read the document.

### BACKGROUND OF THE INVENTION

1. Field of the Invention

The present invention relates to an image reading apparatus which is capable of reading both sides of a document, and an image forming apparatus provided with the image reading apparatus.

2. Description of the Related Art

Conventionally, in image forming apparatuses such as a copying machine and a facsimile machine, front and back sides of a document is read automatically by an image reading apparatus provided with an automatic document feeding device (ADF: Automatic Document Feeder). In this document reading, a method of reading an image on a front side of a document with an image sensor, reversing the document front and back, and reading an image on a back side of the document with the image sensor again has been widely adopted.

Further, as shown in a patent document 1 (Japanese Patent Unexamined Publication No. 2007-82033), there has been a known image forming apparatus adopting a method of providing image sensors respectively for both front and back sides of a document in a document conveying passage from a document tray to substantially simultaneously reading both sides of the document at one document conveyance (one-path) without reversing the document. In the image forming apparatus adopting the method of substantially simultaneously reading both sides of the document, it is likely that reading one side of the document is performed with a minification optical system image sensor provided on a side of an apparatus main body, and reading the other side of the document is performed with a contact type optical system image sensor provided on a side of the automatic document feeding device in view of installation space, cost, and the like.

In the image forming apparatus shown in the patent document 1, the contact type optical system image sensor adapted to read the other side of the document is arranged in a document conveying passage on a downstream side in the document conveying direction from the minification optical system image sensor document which is adapted to read the one side, as shown in FIG. 12 of the patent document 1. However, there has been proposed an image forming apparatus in which the contact type optical system image sensor is provided in the document conveying passage on an upstream side in the document conveying direction from the minification optical system image sensor provided on the side of the apparatus main body.

In a case where the contact type optical system image sensor is arranged on an upstream side in the document conveying direction from the minification optical system image sensor on the side of the apparatus main body, the contact type optical system image sensor is arranged in the document conveying passage between the document tray of the automatic document feeding device and the minification optical system image sensor. Therefore, after starting conveying the document on the document tray, the document reading in the image forming apparatus is performed earlier as compared to the case of the image forming apparatus in which the contact type optical system image sensor is arranged on a downstream side in the document conveying direction from the minification optical system image sensor. Accordingly, from the starting of conveying the document on the document tray, the automatic document feeding device conveys the document at a document reading speed at which the contact type optical system image sensor can read the document. Then, even in the case of the double-sided reverse-reading mode of not reading the document with the contact type optical system image sensor, the automatic document feeding device conveys the document from the document tray at a document speed at which the contact type optical system image sensor can read the document.

Therefore, in a case of reading the document in the double-sided reverse-reading mode, the image forming apparatus in which the contact type optical system image sensor is arranged on an upstream side in the document conveying direction from the minification optical system image sensor requires more time between starting conveying the document and reading the document with the minification optical system image sensor as compared to the image forming apparatus in which the contact type optical system image sensor is arranged on a downstream side in the document conveying direction from the minification optical system image sensor. Accordingly, there has been a problem that the document reading, an image processing, and an image forming on a recording sheet are delayed.

### SUMMARY OF THE INVENTION

The present invention was made to solve the problem described above, and its object is to enable starting the document reading and the image forming to a recording sheet at a timing as early as the image forming apparatus, in which the second reading section is arranged on a downstream side in the document reading direction from the first reading section, during the document reading in the double-sided reverse-reading mode even if the second reading section adapted to read the other side of the document is arranged on an upstream side in the document conveying direction from the first reading section. For example, according to the present invention, the document reading and the image forming to the recording sheet can be started at a timing as early as the image forming apparatus in which the contact type optical system image sensor is arranged on a downstream side in the document conveying direction from the minification optical system image sensor during the document reading in the double-sided reverse-reading mode even in the case of the image forming apparatus in which the contact type optical system image sensor is arranged on an upstream side in the document conveying direction from the minification optical system image sensor.

In summary, according to an aspect of the present invention, an image reading apparatus includes: a document feeding section which feeds a document; a first reading section which reads one side of the document conveyed by the document feeding section; a second reading section which is arranged on an upstream of the first reading section in a document conveying direction and reads other side of the document conveyed by the document feeding section; a reversing section which reverses and conveys the document in such a manner that the other side of the document is to be read by the first reading section after the one side of the document is read by the first reading section; and a controller which controls respective sections to perform a document reading operation in either one of a double-sided reverse-reading mode, in which the first reading section reads the other side of the document after the one side of the document is read by the first reading section and then the document is reversed by the reversing section, or a double-sided simultaneous-reading mode, in which the first reading section reads the one side of the document and the second reading section reads the second reading section reads the other side of the document at one document conveyance performed by the document feeding section. During the document reading operation in the double-sided reverse-reading mode, the controller allows the document feeding section to convey the document at a predetermined speed which is faster than a predetermined document reading speed at which the second reading section can read the document when the document passes through a document reading position of the second reading section, and the controller allows the document feeding section to convey the document at a predetermined document reading speed at which the first reading section can read the document when the document passes through a document reading position of the first reading section.

### BRIEF DESCRIPTION OF THE DRAWINGS

FIG. 1 is a vertical sectional view schematically showing an internal configuration of a complex machine which is an image forming apparatus in accordance with an embodiment of the present invention.

FIG. 2 shows details of a document conveying path of a document feeding section.

FIG. 3 is a block diagram showing an electrical configuration of the complex machine.

FIG. 4 is a flowchart showing a first embodiment of a document reading and a document conveying speed control performed in the complex machine.

FIG. 5 is a flowchart showing a second embodiment of a document reading and a document conveying speed control performed in the complex machine.

FIG. 6 is a flowchart showing a third embodiment of a document reading and a document conveying speed control performed in the complex machine.

### DETAILED DESCRIPTION OF THE PREFERRED EMBODIMENTS

Hereinafter, an image reading apparatus and an image forming apparatus in accordance with embodiments of the present invention will be described with reference to the drawings. In the embodiments described herebelow, an image reading apparatus and an image forming apparatus in accordance with the present invention will be described in a form of a complex machine having functions of a color copying machine, a scanner, a facsimile machine, and a printer.

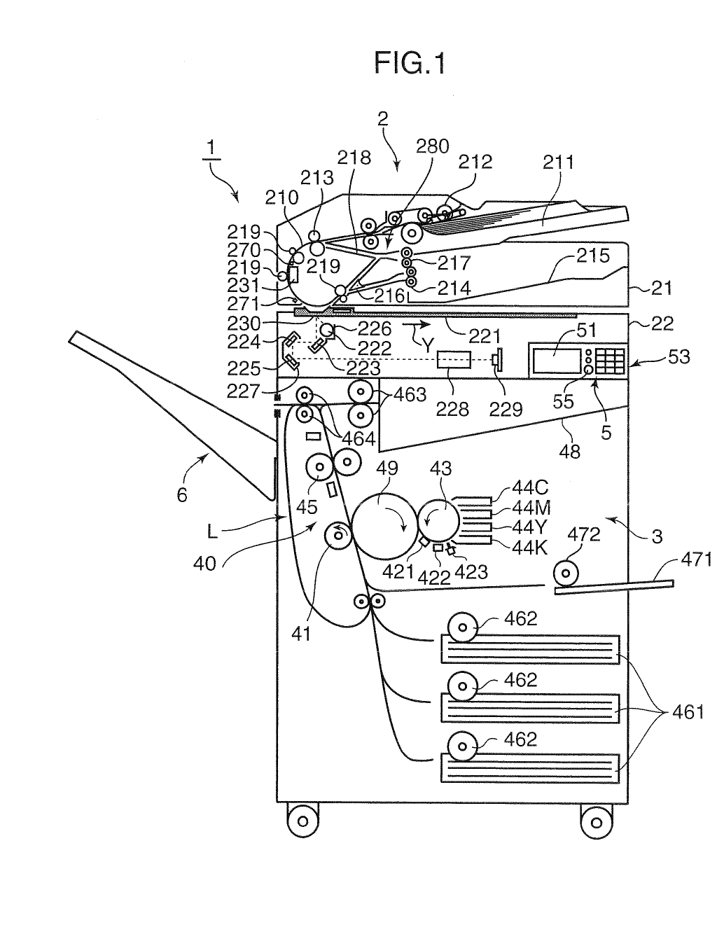

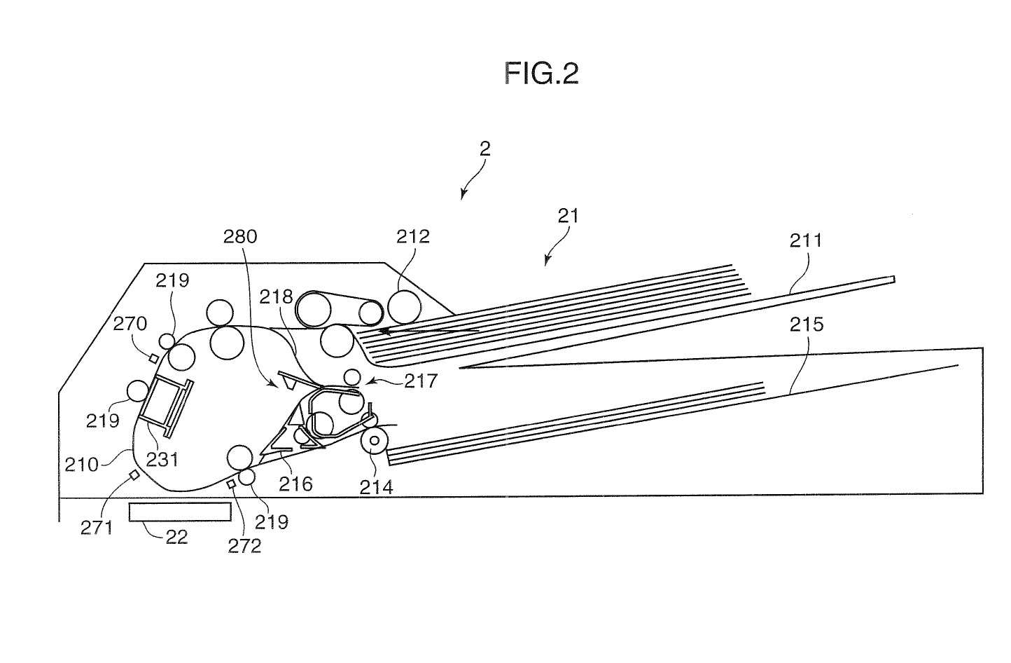

FIG. 1 is a vertical sectional view schematically showing an internal configuration of a complex machine 1 which is an image forming apparatus in accordance with an embodiment of the present invention. FIG. 2 shows details of a document conveying path of the document feeding section 21.

The complex machine 1 includes an image reading apparatus 2 and an apparatus main body 3. The image reading apparatus 2 includes a document feeding section 21, a scanner section 22, a CIS 231, and an operating section 5, and further includes a reversing mechanism 280 and a controller 61 which will be described hereinafter.

The document feeding section 21 is provided with an ADF (Automatic Document Feeder) and includes a document tray 211, a pickup roller 212, a registration roller 213, a document conveying roller 219, a sheet-discharging roller 214, and a sheet-discharging tray 215. On the document tray 211, a document subjected to reading is held. The document held on the document tray 211 is taken by the pickup roller 212 one after another. A timing of conveying the document taken by the pickup roller 212 to the CIS 231 and the scanner section 22 is adjusted by the registration roller 213 in accordance with a progress of reading in the CIS 231 and the scanner section 22 and a position on a document conveying passage about a document which is started to be read precedingly. After adjusting the timing, the registration roller 213 starts conveying the document to the CIS 231 and the scanner section 22, and the document is conveyed on the document conveying passage 210 by each document conveying roller 219 provided in the document conveying passage 210. The document conveyed by each document conveying roller 219 in the document conveying passage 210 is discharged to the sheet-discharging tray 215 by the sheet-discharging roller 214.

The scanner section (first reading section) 22 optically reads an image of the document to generate image data. The scanner section 22 is provided in the apparatus main body 3. The scanner section 22 includes a platen glass 221, a light source 222, a first mirror 223, a second mirror 224, a third mirror 225, a first carriage 226, a second carriage 227, an imaging lens 228, and a CCD (Charge Coupled Device) 229. In the scanner section 22, a white fluorescent lamp such as a cold cathode fluorescent tube is used as the light source 222. The first mirror 223, the second mirror 224, the third mirror 225, the first carriage 226, the second carriage 227, and the imaging lens 228 lead a light from the document to the CCD 229. Since a white fluorescent lamp such as a cold cathode fluorescent tube is used as the light source 222 in the scanner section 22, a color reproductivity is better than that of the below-described CIS 231 adopting three-colored LED and the like as a light source.

Further, on an upstream side in the document conveying direction of the document conveying passage 210 of the scanner section 22, a second document detection sensor 271 which is configured by a light sensor and the like and adapted for detecting a leading end of a document is provided. The second document detection sensor 271 is configured by a light sensor having, for example, a light emitter and a light receiver provided at such positions as to face each other across the document conveying passage 210. When a light emitted from the light emitter is shut by a document conveyed in the document conveying passage 210, and the light is not received by the light receiver, it is detected that the document leading end arrives at a detecting position of the second document detection sensor 271. Then, the second document detection sensor 271 outputs a document detection signal indicating the detection of the document leading end to the controller 61. The distance between the second document detection sensor 271 and the scanner section 22 is so set that when a leading end of a document being conveyed or an image forming area except for a white space arrives at the image reading position of the scanner section 22 in a case where the document leading end is detected and thereafter the controller 61 changes the document conveying speed of the pickup roller 212, the registration roller 213, and the document conveying roller 219 of the document feeding section 21 from a predetermined speed which is faster than a document image readable speed of the scanner section 22 to the document image readable speed, the document conveying speed is securely changed to be the document image readable speed.

At a time of reading a document without using the document feeding section 21, a user manually places the document onto the platen glass 221. The light source 222 and the first mirror 223 is supported by the first carriage 226. The second mirror 224 and the third mirror 225 are supported by the second carriage 227.

The image reading apparatus 2 has document-reading methods including a flat-bed reading mode, in which the scanner section 22 reads a document placed on the platen glass 221, and an ADF reading mode, in which a document is taken in by the document feeding section 21 (ADF) and read while being conveyed. In the flat-bed reading mode, the light source 222 irradiates a light to the document placed on the platen glass 221, and a reflected light for one line in a main scanning direction is reflected sequentially by the first mirror 223, the second mirror 224, and the third mirror 225 and enters the imaging lens 228. The light incident to the imaging lens 228 is imaged on a receiving surface of the CCD 229. The CCD 229 is a one-dimensional image sensor and processes one line of a document image simultaneously. The first carriage 226 and the second carriage 227 are so configured as to be movable in a direction orthogonal to the main scanning direction (sub-scanning direction, the direction of an arrow Y). After reading of one line is terminated, the first carriage 226 and the second carriage 227 move in the direction perpendicular to the main scanning direction, and next reading of line is performed.

In the ADF reading mode, the document feeding section 21 takes in a document placed on the document tray 211 one after another with the pickup roller 212. At this time, the first carriage 226 and the second carriage 227 are arranged at positions under a reading window 230. When the document is conveyed by the document feeding section 21 and passes through the reading window 230 formed in the document conveying passage 210, the light source 222 irradiates a light to the document. A reflected light for one line in the main scanning direction is reflected sequentially by the first mirror 233, the second mirror 224, and the third mirror 225, and enters the imaging lens 228. The light incident to the imaging lens 228 is imaged on the receiving surface of the CCD 229. Next, the document is conveyed by the document feeding section 21, and the next line is read.

Further, the document feeding section 21 includes a reversing mechanism 280 (reversing section) configured by a switching guide 216, a reversing roller 217, and a reversing conveying passage 218. The reversing mechanism 280 reverses the document, whose front side (one side of the document) is read by the scanner section 22 at the first ADF reading, front and back and conveys the document again to the reading window 230 (scanner section 22), so that a back side (the other side of the document) is read again by the scanner section 22. The reversing mechanism 280 operates only at a time of double-sided reading, and it does not operate at a time of one-sided reading. After the one-sided reading, and reading of the back side in the double-sided reading, the switching guide 216 is switched to an upper side, and the document is discharged to the sheet-discharging tray 215 by the sheet-discharging roller 214. Further, after reading the front side in the double-sided reading, the switching guide 216 is switched to a lower side. The document conveyed by the document conveying roller 219 is conveyed to the reversing conveying passage 218 by a reverse rotation of the reversing roller 217, and then conveyed again to the reading window 230 (scanner section 22) by the conveying roller 219. Hereinafter, the mode of reading both sides of the document with the reversing mechanism 280 is named as a double-sided reverse-reading mode or a high image quality mode.

Further, in the ADF reading mode, the image reading apparatus 2 in accordance with the present embodiment is capable of allowing the scanner section 22 (CCD 229) to read a document side while the document is conveyed and read the back side of the document with the CIS (second reading section) 231 simultaneously, as described above. As shown in FIG. 2, the CIS 231 is arranged at a position on an upstream side in the document conveying direction of the scanner section 22 and between the document tray 211 and the scanner section 22 on the document conveying passage 210. In this case, the back side of the document conveyed by the document feeding section 21 from the document tray 211 is read at a time of passing through a part at which the CIS 231 is arranged, and the front side is read by the CCD 229 at a time of passing above the reading window 230. Further, in the CIS 231, a three-colored LED of RGB or the like is used as a light source.

Further, on an upstream side from the CIS 231 in the document conveying direction in the document conveying passage 210, there is provided a first document detection sensor 270 which is configured by a light sensor or the like adapted to detect a leading end of the document. The first document detection sensor 270 is configured by, for example, a light sensor having a light emitter and a light receiver provided at positions facing each other across the document conveying passage 210. When a light emitted from the light emitter is shut by the document conveyed through the document conveying passage 210 so that the light receiver cannot receive the light, it is detected that the document leading end arrives at a detecting position of the first document detection sensor 270. The first document detection sensor 270 outputs a document detection signal indicating detection of a document leading end to the controller 61. The distance between the first document detection sensor 270 and the CIS 231 is so set that when a leading end of the document being conveyed or an image forming area except for a white space arrives at the image reading position of the CIS 231 in a case where the document leading is detected and thereafter the controller 61 changes the document conveying speed of the pickup roller 212, the registration roller 213, and the document conveying roller 219 of the document feeding section 21 from a predetermined speed which is faster than a document readable speed of the CIS 231 to the document image readable speed, the document conveying speed is securely changed to the document readable speed.

By using the CCD 229 and the CIS 231 as described above, front and back sides of the document can be read by the document feeding section 21 with one document conveying operation (one-path) from the document tray 211 to the sheet-discharging tray 215. Hereinafter, the mode of using the CCD 229 and the CIS 231 to read both sides of the document will be named as a double-sided simultaneous-reading mode or a high-speed mode.

The high image quality mode (double-sided reverse-reading mode) and the high-speed mode (double-sided simultaneous-reading mode) will be described. In the high image quality mode, the double-sided document reading is performed by the same image sensor (CCD 229). Therefore, even if the double-sided printing is performed in accordance with obtained image data, there is no difference in image quality between both sides. However, in the high-speed mode, the front side of the document is read by the CCD 229, and the back side is read by the CIS 231, i.e. the reading is performed with different image sensors. Therefore, especially in the case of a color document, if the double-sided printing is performed in accordance with image data obtained respectively by the respective image sensors, image quality of print images on both sides becomes different. It is thought that such difference in image quality occurs because, in addition to the reason that difference in spectral distribution of the light sources which are used for the CCD 229 and the CIS 231 at the time of document reading, the CCD 229 is configured as an image sensor in which a plurality of receiving devices are formed on one chip, and on the other hand, the CIS 231 is configured as an image sensor in which a plurality of solid imaging devices are connected, causing irregularity in sensitivity of solid imaging devices.

Thus, in the complex machine 1 in accordance with the present embodiment, for the purpose of solving occurrence of the difference in image quality, it is so configured that a user can select one of the high image quality mode (double-sided reverse-reading mode) and the high-speed mode (double-sided simultaneous-reading mode) when the double-sided document reading is performed with the ADF reading mode. In other words, a user can select a mode according to a situation by selecting the high image quality mode (double-sided reverse-reading mode) in a case where a user would like to have equal image quality of print images on both sides, or selecting the high-speed mode (double-sided simultaneous-reading mode) in a case where a user would like to prioritize shortening of a reading time even if the image quality differs in print images on both sides.

Further, the complex machine 1 includes an apparatus main body 3 and a stack tray 6 provided on a left side of the apparatus main body 3. The apparatus main body 3 includes a plurality of sheet-feeding cassettes 461, sheet-feeding rollers 462 for conveying recording sheets one after another from the sheet-feeding cassette 461 to the recording section 40, and a recording section 40 for forming an image onto the recording sheets conveyed from the sheet-feeding cassettes 461. Further, a manual feeding tray 471 is provided. Sheets having a size which is not accommodated in any of the sheet-feeding cassettes, sheets in which an image is already formed on one side, and any recording mediums such as OHP sheets can be placed on the manual feeding tray 471, and the sheets are fed one after another by a sheet feeding roller 472 from the manual feeding tray 471 into the apparatus main body 3.

The recording section (image forming section) 40 includes a charge-removing device 421 for removing remaining electric charge from a surface of the photoconductive drum 43, a charging device 422 for charging the surface of the photoconductive drum 43 after removal of electric charge, an exposure device 423 for outputting laser light in accordance with image data obtained in the scanner section 22 for exposure of the surface of the photoconductive drum 43 to form an electrostatic latent image on the surface of the photoconductive drum 43, developing devices 44K, 44Y, 44M, and 44C for forming toner images of cyan (C), magenta (M), yellow (Y), and black (K) onto the photoconductive drum 43 in accordance with the electrostatic latent image, a transfer drum 49 onto which the toner images of respective colors formed on the photoconductive drum 43 are transferred and superimposed, a transferring device 41 for transferring the toner image formed on the transfer drum 49 to the sheet, and a fixing device for heating the sheet, onto which the toner image is transferred, to fix the toner image. The toners of respective colors of cyan, magenta, yellow, and black are supplied from an unillustrated toner-supply container (toner cartridge). Further, there are provided conveying rollers 463 and 464 for conveying the recording sheet passed through the recording section 40 to the stack tray 6 or the sheet-discharging tray 48.

In a case of forming images on both sides of a recording sheet, an image is formed on one side of the recording sheet in the recording section 40, and thereafter the recording sheet is nipped between the conveying rollers 463 on the side of the sheet-discharging tray 48. In this state, the conveying rollers 463 are reversely rotated so that the recording sheet is switched back. Then, the recording sheet is sent to a sheet conveying passage L and conveyed again to an upstream area of the recording section 40. After an image is formed on the other side in the recording section 40, the recording sheet is discharged to the stack tray 6 or the sheet-discharging tray 48.

Further, on a front side of the apparatus main body 3, there is provided an operating section having a display portion which allows a user to visually confirm an operation screen and various massages, and operation buttons for inputting various operation commands. The operating section 5 includes a display portion 51, a numerical key group 53, and a start button 55. The display portion 51 is configured by an LCD (Liquid Crystal Display), an ELD (Electronic Luminescent Display), or the like and displays guide screens for operations such as a sheet size selection, a magnification selection, a density selection, and the like with respect to a user. The display portion 51 is integrally formed with a touch panel. When a user performs a touch operation, the touch panel detects a touched position and outputs a detection signal to the controller which will be described herebelow.

The numerical key group 53 is operative to input the number of copies at a time when the copying function of the complex machine 1 is operated, and phone numbers of an addressee at a time when the facsimile is operated. For example, the start button 55 is a button which is operative to start the copying operation and the scanner operation.

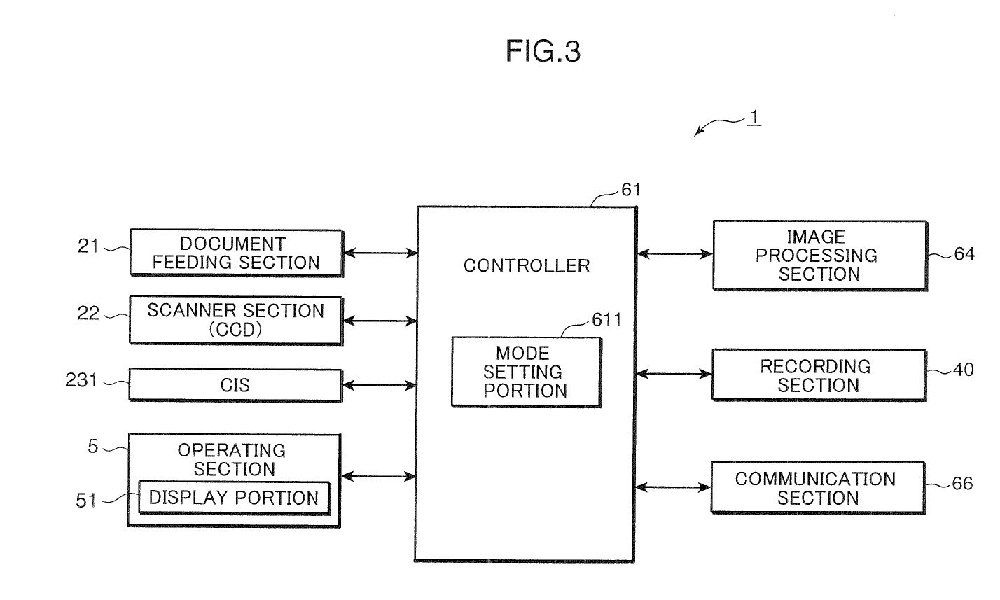

FIG. 3 is a block diagram showing an electrical configuration of the complex machine 1. The elements which are the same as those shown in FIGS. 1 and 2 are identified by the same reference numerals, and detailed description regarding those will be omitted.

The complex machine 1 is configured by the controller 61, the document feeding section 21, the scanner section 22, the CIS 231, the operating section 5, the image processing section 64, the recording section 40, and the communication section 66.

The controller 61 controls an overall operation of the complex machine 1 and is configured by a CPU and the like. The document feeding section 21, the scanner section 22, the CIS 231, the operating section 5, the image processing section 64, the recording section 40, and the communication section 66 are operated under a control executed by the controller 61. The controller 61 executes a processing based on an operation control program stored in an unillustrated ROM or HDD in accordance with various instruction signals inputted to the operating section 5 by a user, outputs the instruction signals to respective functional sections, and performs data transfer to totally control the complex machine 1.

A drive power source for the pickup roller 212, the registration roller 213, the document conveying roller 219, and the sheet-discharging roller 214 of the document feeding section 21 includes, for example, a stepping motor, and the controller 61 controls driving of the stepping motor (including a driving mechanism for the same) as the drive power source to change rotational speeds of the pickup roller 212, the registration roller 213, the document conveying roller 219, and the sheet-discharging roller 214 to control the document conveying speed in accordance with the document reading positions of the CIS 231 and the CCD 229. The pickup roller 212, the registration roller 213, and the document conveying roller 219 are examples of the conveying roller according to claims.

The controller 61 includes a mode setting portion 611. The mode setting portion 611 stores predetermined operations and operation controls for relevant parts of the document feeding section 21, the scanner section 22, the CIS 231, and the reversing mechanism 280 in the double-sided reverse-reading mode and the double-sided simultaneous-reading mode described above. The mode setting portion 611 is operative to set which of operations of the double-sided reverse-reading mode or the double-sided simultaneous-reading mode is to be performed by the relevant section in accordance with mode selection instructions, which are the instructions of selecting which one of the double-sided reverse-reading mode and the double-sided simultaneous-reading mode, to be inputted by a user through operation to the operating section 5. The controller 61 controls the relevant sections to operate in a mode set by the mode setting portion 611. In the description herebelow, the scanner section 22 will be presented as the CCD 229.

The document feeding section 21 automatically takes in a document placed on the document tray 211 and conveys the document so as to be readable by the CCD 229 and the CIS 231 when copying and scanning of a document is performed in the ADF reading mode.

The display portion 51 is adapted to display various screens and displays a display screen in accordance with a display signal inputted from the controller 61.

The image processing section 64 is adapted to perform various image processing related to image data. For example, the image processing section 64 performs correction processing such as a level correction and a gamma correction, a compression or expanding processing with respect to image data, and image processing such as enlarging or reducing processing with respect to image data obtained by the CCD 229 or CIS 231, and image data transferred through a communication section 66 such as a personal computer connected to a network or a facsimile machine connected through a public phone line.

The recording section 40 forms on a recording sheet an image based on image data obtained by the CCD 229 or CIS 231 and image data transferred through the communication section 66 from a personal computer, a facsimile machine, and the like.

The communication section 66 is adapted to perform a transmission of various data between external devices such as a computer and facsimile machine connected through a network by using a network interface.

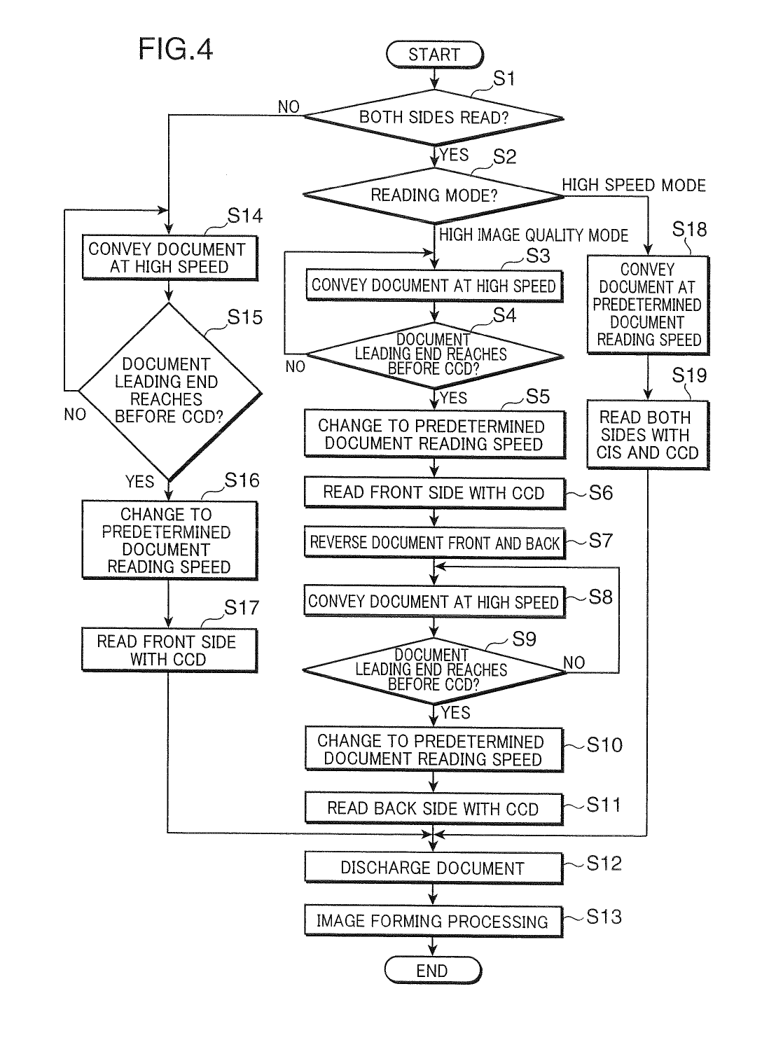

Next, a first embodiment of a document reading and a document conveying speed control performed by the complex machine 1 will be described. FIG. 4 is a flowchart of the first embodiment of the document reading and the document conveying speed control performed by the complex machine 1.

For example, a document stack arranged in a face-up state is placed on the document tray 211 by a user, and a copying function of the complex machine 1 is selected by a user's operation to the operating section 5, the controller 61 determines whether (1) an input of an instruction of reading both sides of a document and performing one-sided printing or double-sided printing, or (2) an input of an instruction of reading one side of a document and performing one-sided printing or a double-sided printing is inputted to the operating section 5 (S1).

If (1) the input of the instruction of reading both sides of a document and performing one-sided printing or double-sided printing is received by the operating section 5 (YES in S1), the controller 61 determines which one of a document reading instruction of a high image quality mode and a high-speed mode is received by the operating section 5 (S2).

When a document reading instruction of a high image quality mode is received by the operating section 5 through a user's operation (“high image quality mode” in S2), and the start button 55 is pressed by the user, the controller 61 outputs a signal to the document feeding section 21 to instruct taking in a document at a high speed so as to allow the pickup roller 212 to take in a document placed on the document tray 211 and allow the registration roller 213 and the document conveying roller 219 to convey the document toward the reading window 230 formed in a lower side (S3). In other words, in S3, the controller 61 controls operations of the pickup roller 212 and the registration roller 213 of the document feeding section 21 and the driving mechanism of the document conveying roller 219 to allow the pickup roller 212, the registration roller 213 and the document conveying roller 219 to convey a document at a predetermined speed SD2 which is faster than a predetermined document reading speed SD1 at which an image of a document can be read by the CIS 231.

After that, when a leading end of the conveyed document reaches before the CCD 229, and the document leading end is detected by the second document detection sensor 271, and the second document detection sensor 271 sends a document detection signal to the controller 61 (YES in S4), the controller 61 controls operations of driving mechanisms of relevant parts including the pickup roller 212, the registration roller 213, and the document conveying roller 219 to change the document conveying speed SD2 at this point of time to the document reading speed SD3 at which the CCD 229 can read the document (S5). The CCD 229 reads a side of the document conveyed at the document reading speed SD3 to the reading window 230 (S6).

After reading the document side, the reversing mechanism 280 reverses the document front and back and conveys the document again to the reading window 230 (CCD 229) (S7). However, after the document is reversed front and back by the reversing mechanism 280, the controller 61 switches a conveying speed of the document to the document conveying speed SD2 which is a high speed (S8).

After the document is reversed front and back, when a leading end of the conveyed document arrives before the CCD 229 again, and the document leading end is read by the second document detection sensor 271, and a document detection signal is sent from the second document detection sensor 271 to the controller 61 (YES in S9), the controller 61 changes the document conveying speed SD2 at this point of time to the document treading speed SD3 again at which the document can be read by the CCD 229 (S10). The CCD 229 reads a back side of the document conveyed at the document reading speed SD3 to the reading window 230 (S11). The document feeding section 21 discharges a document, whose front and back sides are read, to the sheet-discharging tray 215 (S12). The controller 61 repeatedly performs the processing of S3 through S12 to all of documents placed on the document tray 211.

Next, the controller 61 controls the image processing section 64 to perform a necessary image processing to image data of front and back sides of each document obtained by the CCD 229 and controls the recording section 40 to perform image forming of corresponding image data to the front and back sides of the recording sheet in accordance with the image data to which the image processing is applied (S13). Even during the processing of S3 through S12 with respect to each document, the controller 61 allows image forming processing to the recording sheet to be started regarding image data whose image can be formed (S13). However, the image forming can be started after the processing of S3 through S12 to all of documents placed on the document tray 211 is terminated.

Further, when the document reading instruction in a high-speed mode is received by the operating section 5 through the user's operation in S2 (“high-speed mode” in S2), and the start button 55 is pressed by the user, the controller 61 outputs a signal to the document feeding section 21 to take in a document, allows the pickup roller 212 to take in the document placed on the document tray 211, and allows the registration roller 213 and the document conveying roller 219 to convey the document toward the reading positions of the CIS 231 and the CCD 229 (S18). In S18, the controller 61 controls driving mechanisms of the pickup roller 212, the registration roller 213, and the document conveying roller 219 of the document feeding section 21 to allow the pickup roller 212, the registration roller 213, and the document conveying roller 219 to convey a document at the document reading speed SD1 at which the CIS 231 can read the document. During one document conveying operation is performed by the document feeding section 21, the CIS 231 reads a back side of the document, and the CCD 229 reads a side of the document conveyed to the reading window 230 (S19). The document feeding section 21 discharges the sheet, whose front and backs sides are read, to the sheet-discharging tray 215 (S12). The processing in which the controller 61 repeatedly performs the processing of S18, S19, and S12 to all of documents placed on the document tray 211, and the image forming processing based on image data of front and back sides of each document (S13) are performed similarly to the case of the high image quality mode.

When an instruction of reading one side of a document and printing on one side or both sides of a recording sheet is received by the operating section 5 from a user in S1 (NO in S1), the controller 61 outputs a signal to the document feeding section 21 to take in a document and controls the document feeding section 21 to convey the document at the document conveying speed SD2 which is a high speed (S14).

After that, if a leading end of the conveyed document reaches before the CCD 229, and the document leading end is detected by the second document detection sensor 271, and a document detection signal is sent to the controller 61 from the second document detection sensor 271 (YES in S15), the controller 61 changes the document conveying speed SD2 at this point of time to the document reading speed SD3 at which the CCD 229 can read the document (S16). The CCD 229 reads a front side of the document conveyed to the reading window 230 at the document reading speed SD3 (S17).

Accordingly, in a case where the document reading is performed in the double-sided reverse-reading mode, the document passes through the document reading position of the CIS 231, at which the document reading is not performed, so that a time from starting conveying the document to starting of reading the document at the CCD 229 can be shortened more than the conventional manner. Therefore, even if the CIS 231 is arranged on an upstream side in the document conveying direction from the CCD 229, at a time of reading a document in the double-sided reverse-reading mode, a document reading, an image processing, and an image forming with respect to a recording sheet can be started at a timing as early as a case of an image forming apparatus in which the CIS 231 is arranged on a downstream side in the document conveying direction from the CCD 229.

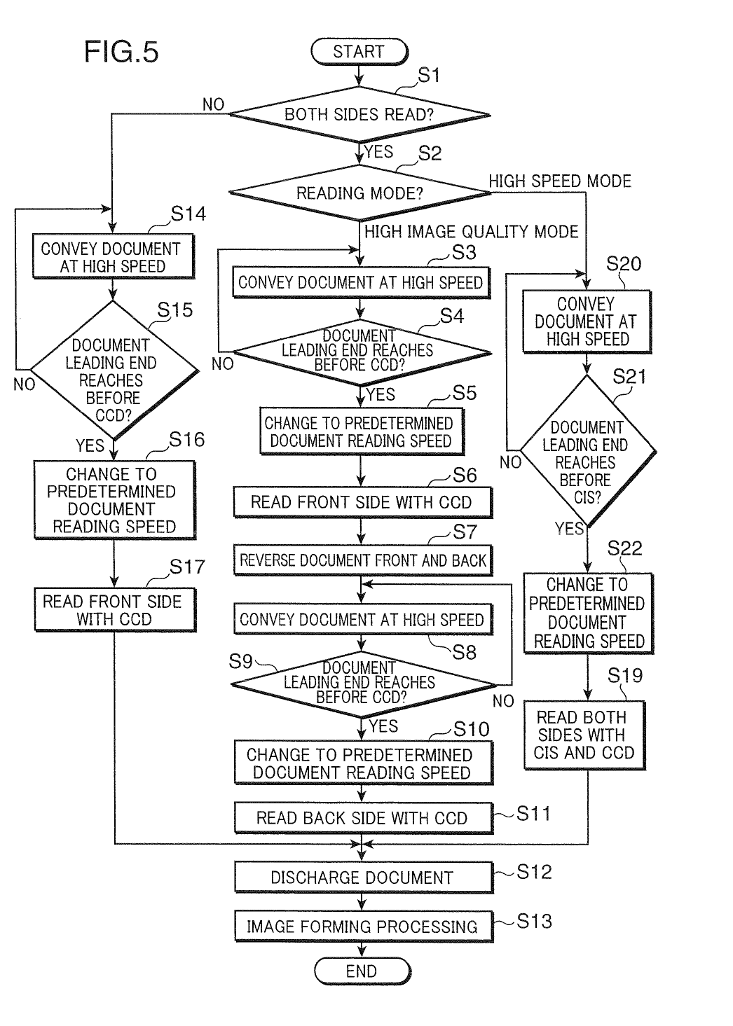

Next, a second embodiment of a document reading and a document conveying speed control performed by the complex machine 1 will be described. FIG. 5 is a flowchart showing a second embodiment of a document reading and a document conveying speed control performed by the complex machine 1. The processing which are the same as those of the first embodiment shown in FIG. 4 will be identified by the same reference sign, and description regarding those will be omitted.

In the first embodiment, when a user selects a document reading in the high image quality mode, the controller 61 performs a control of setting the document conveying speed at the time of passing through the CIS 231 to be the second document conveying speed SD2 which is a high-speed. However, in the second embodiment, also in a case where a document reading in the high-speed mode is selected by a user, the controller 61 performs a control of setting the document conveying speed to be the document conveying speed SD2 which is faster than the document reading speed SD1 of the CIS 231 until the document reaches the document reading position of the CIS 231 (S20, S21).

In other words, when the document reading instruction in the high-speed mode is received by the operating section 5 through a user's operation (“high-speed mode” in S2), and the start button 55 is pressed by the user, the controller 61 outputs a signal to instruct the document feeding section 21 to take in a document at a high speed to allow the pickup roller 212 to take in a document placed on the document tray 211, and allows the registration roller 213 and the document conveying roller 219 to convey the document to the CIS 231 and the CCD 229 (S20). In S20, the controller 61 allows the pickup roller 212, the registration roller 213, and the document conveying roller 219 to convey the document at the document conveying speed SD2 which is faster than the document reading speed SD1 at which the CIS 231 can read the document.

After that, when a leading end of the conveyed document reaches before the CIS 231, and the first document detection sensor 270 detects the document leading end, and the first document detection sensor 270 sends a document detection signal to the controller 61 (YES in S21), the controller 61 controls driving mechanisms of relevant parts including the pickup roller 212, the registration roller 213, and the document conveying roller 219 to change the document conveying speed SD2 at this point of time to the document reading speed SD1 at which the CIS 231 can read a document (S22). The CIS 231 and the CCD 229 read front and back sides of the document conveyed at the document reading speed SD1 (S19). In the present embodiment, it is given a condition that the CCD 229 can read a document at a speed which is equal to or faster than the document reading speed SD1 at which the CIS 231 can read a document (the document reading speed SD1 in the CIS 231≦the document readable speed in the CCD 229).

Accordingly, a time from starting of conveying a document in the double-sided simultaneous-reading mode to starting of reading the document at the CIS 231 can be shortened more than the conventional manner, and a document reading, an image processing, and an image forming to a recording sheet can be started earlier than the document reading in the conventional double-sided simultaneous-reading mode.

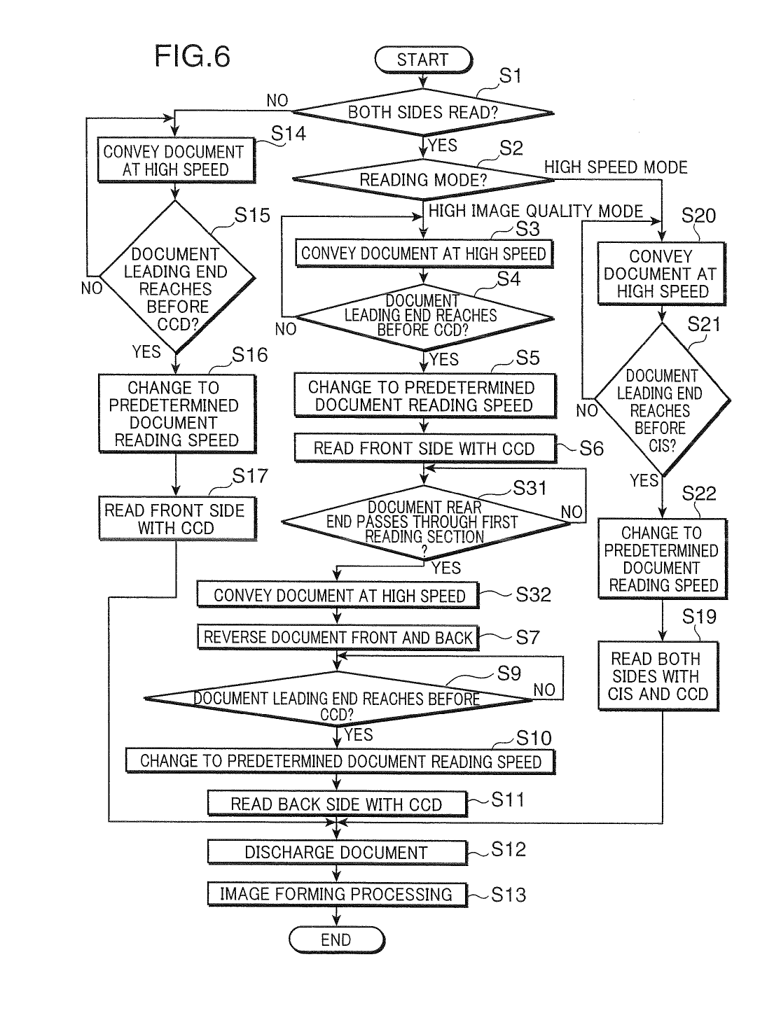

The present invention is not limited to the configuration of the embodiments, and various modifications can be made. FIG. 6 is a flowchart showing a document reading and a document conveying speed control performed by the complex machine 1 in accordance with the third embodiment. The processing which are the same as the second embodiment shown in FIG. 5 are identified by the same reference numerals, and description regarding those will be omitted. The third embodiment will be described with reference to FIG. 6 and the already referred FIG. 2.

In the first and second embodiments, at the time of document reading operation in the high image quality mode, the controller 61 performs a control of changing a speed to be the document conveying speed SD2 which is a high speed (S8) after the CCD 229 reads the document side (S6), and a document reversing operation is performed (S7). However, alternatively in the third embodiment, a third document detection sensor 272 (FIG. 2) having a configuration which is the same as the first document detection sensor is provided on a downstream side in the document conveying direction from the document reading position of the CCD 229. When the third document detection sensor 272 detects a rear end of a document, in other words, when the document rear end passes through the document reading position of the CCD 229 (YES in S31), the controller 61 changes a speed to be the document conveying speed SD2 which is a high speed (S32). The controller 61 allows the front and back reversing operation with respect to the document to be performed after changing to the document conveying speed SD2. Similarly to the first and second embodiments, when a leading end of the conveyed document reaches before the CCD 229 again, and the second document detection sensor 271 detects the document leading end (YES in S9), the controller 61 changes the document conveying speed SD2 to the document reading speed SD3 (S10).

According to the third embodiment, the document conveying speed is changed to be the document conveying speed SD2 which is a high speed at a stage earlier than that in the second embodiment, the document reading by the scanner section 22 and the image forming operation by the recording section 40 can be started at an earlier timing.

Without providing the third document detection sensor 272 described above, the controller 61 may change a speed to be the document conveying speed SD2, which is a high speed, after the first document detection sensor 270 or the second document detection sensor 271 detects the document rear end, and after a passage of time after the rear end of the document passes through the reading position.

Further, the present embodiment is so configured that the first reading section which reads front and back sides of the document during the document reading operation in the double-sided reverse-reading mode or reads the document sides during the document reading operation in the double-sided simultaneous-reading mode is the CCD 229, and the second reading section which reads the document back side during the document reading operation in the double-sided simultaneous-reading mode is the CIS 231. However, it may be so configured that both the first and second reading sections are the CIS 231.

Further, in the above, embodiments of configurations and processing of the image reading apparatus and the image forming apparatus according to the present invention are shown in FIGS. 1 through 5. However, these are mere examples, and the image reading apparatus and the image forming apparatus according to the present invention are not limited to the configurations and controls described above.

In summary, according to an aspect of the present invention, an image reading apparatus includes: a document feeding section which feeds a document; a first reading section which reads one side of the document conveyed by the document feeding section; a second reading section which is arranged on an upstream of the first reading section in a document conveying direction and reads other side of the document conveyed by the document feeding section; a reversing section which reverses and conveys the document in such a manner that the other side of the document is to be read by the first reading section after the one side of the document is read by the first reading section; and a controller which controls respective sections to perform a document reading operation in either one of a double-sided reverse-reading mode, in which the first reading section reads the other side of the document after the one side of the document is read by the first reading section and then the document is reversed by the reversing section, or a double-sided simultaneous-reading mode, in which the first reading section reads the one side of the document and the second reading section reads the second reading section reads the other side of the document at one document conveyance performed by the document feeding section. During the document reading operation in the double-sided reverse-reading mode, the controller allows the document feeding section to convey the document at a predetermined speed which is faster than a predetermined document reading speed at which the second reading section can read the document when the document passes through a document reading position of the second reading section, and the controller allows the document feeding section to convey the document at a predetermined document reading speed at which the first reading section can read the document when the document passes through a document reading position of the first reading section.

Further, according to an aspect of the present invention, an image forming apparatus includes: a document feeding section which feeds a document; a first reading section which reads one side of the document conveyed by the document feeding section; a second reading section which is arranged on an upstream of the first reading section in a document conveying direction and reads other side of the document conveyed by the document feeding section; a reversing section which reverses and conveys the document in such a manner that the other side of the document is to be read by the first reading section after the one side of the document is read by the first reading section; a controller which controls respective sections to perform a document reading operation in either one of a double-sided reverse-reading mode, in which the first reading section reads the other side of the document after the one side of the document is read by the first reading section and then the document is reversed by the reversing section, or a double-sided simultaneous-reading mode, in which the first reading section reads the one side of the document and the second reading section reads the second reading section reads the other side of the document at one document conveyance performed by the document feeding section; and an image forming section which forms an image on a recording sheet in accordance with data of a read image read by the first reading section and the second reading section. During the document reading operation in the double-sided reverse-reading mode, the controller allows the document feeding section to convey the document at a predetermined speed which is faster than a predetermined document reading speed at which the second reading section can read the document when the document passes through a document reading position of the second reading section, and the controller allows the document feeding section to convey the document at a predetermined document reading speed at which the first reading section can read the document when the document passes through a document reading position of the first reading section.

Further, according to the present invention, during the document reading operation in the double-sided reverse-reading mode, the controller switches the document conveyance speed to be the predetermined speed which is faster than a predetermined document reading speed at which the second reading section can read the document after the document is reversed front and back by the reversing section, and the controller switches the document conveyance speed to be the predetermined document reading speed at which the first reading section can read the document when the document passes through the document reading position of the first reading section.

Further, according to the present invention, during the document reading operation in the double-sided reverse-reading mode, the controller switches the document conveyance speed to be the predetermined speed which is faster than a predetermined document reading speed at which the second reading section can read the document when a rear end of the document passes through the document reading position of the first reading section, and the controller switches the document conveyance speed to be the predetermined document reading speed at which the first reading section can read the document when the document passes through the document reading position of the first reading section.

According to the invention, during the document reading operation in the double-sided reverse-reading mode, the controller allows the document feeding section to convey the document at a speed which is faster than a document reading speed at the second reading speed when the document passes through a document reading position of the second reading section which is arranged on an upstream side in the document conveying direction from the first reading section, and the controller allows the document feeding section to change a speed to be a document reading speed at the first reading section when the document passes through the document reading position of the first reading section. Accordingly, when the document is read in the double-sided reverse-reading mode, the document passes through the reading position of the second reading section at which the document reading is not performed, so that a time between starting of conveying a document and reading of the document at the first reading section can be shortened as compared to the conventional manner.

Accordingly, even if the second reading section for reading the other side of the document is arranged on an upstream in the document conveying direction from the first reading section, during the document reading in the double-sided reverse-reading mode, the document reading and image forming to the recording sheet can be started at an early timing similarly to the image forming apparatus in which the second reading section is arranged on an upstream side in the document conveying direction from the first reading section.

Therefore, according to the invention, for example, even if the contact type optical system image sensor is arranged on an upstream side in the document conveying direction from the minification optical system image sensor, during the document reading in the double-sided reverse-reading mode, the document reading and the image forming with respect to the recording sheet can be started at an early timing which is similarly to the image forming apparatus in which the contact type optical system image sensor is arranged on a downstream side in the document conveying section from the minification optical system image sensor.

Further, according to the present invention, the controller controls relevant sections including the first and second reading sections, the document feeding section, and the reversing section to perform the document reading operation in the double-sided reverse-reading mode, the double-sided simultaneous-reading mode, or a one-side reading mode in which the first reading section reads only the one side of the document. During the document reading operation in the one-side reading mode, the controller controls the document feeding section to convey the document at the predetermined speed which is faster than a predetermined document reading speed at which the second reading section can read the document when the document passes through the document reading position of the second reading section, and the controller controls the document feeding section to convey the document at the predetermined document reading speed at which the first reading section can read the document when the document passes through the document reading position of the first reading section.

According to this invention, also during the document reading operation in the one-side reading mode, the document passes through the document reading position of the second reading section, at which the document reading is not performed, at a high speed, so that a time between starting for conveying a document and starting of reading a document at the first reading section can be shortened. Accordingly, even if the second reading section for reading the other side of the document is arranged on an upstream side in the document conveying direction from the first reading section, during the document reading in the one-side reading mode, the document image reading and the image forming to the recording sheet can be started at an early timing similarly to the image forming apparatus in which the second reading section is arranged on a downstream side in the document conveying direction from the first reading section.

Further, according to the present invention, during the document reading operation in the double-sided simultaneous-reading mode, the controller controls the document feeding section to convey the document at the predetermined speed which is faster than a predetermined document reading speed at which the second reading section can read the document until the document arrives at the document reading position of the second reading section, and the controller controls the document feeding section to convey the document at the predetermined document reading speed at which the second reading section can read the document when the document comes to the document reading position of the second reading section.

According to this invention, during the document reading operation in the double-sided simultaneous-reading mode, the controller controls the document feeding section to convey the document at a speed which is faster than a document reading speed in the second reading section until the document arrives at the document reading position of the second reading section, and the controller changes the document conveying speed to be a document reading speed at the second reading section at a point of time when the document comes to the document reading position of the second reading section, so that a time between starting of conveying a document in the double-sided simultaneous-reading mode and starting of reading a document in the second reading section can be shortened as compared to the conventional manner. Accordingly, the document reading and the image forming with respect to a recording sheet can be started at a timing which is earlier than the document reading operation in the conventional double-sided simultaneous-reading mode.

Further, according to the present invention, the document feeding section includes: a conveying roller which conveys the document; and a stepping motor as a drive power source which applies a rotational drive force to the conveying roller, and the controller controls driving of the stepping motor to change a rotational speed of the conveying roller so as to control the document conveyance speed in accordance with the document reading positions of the first and second reading sections.

According to the invention, the stepping motor is a drive power source for the conveying roller, and the controller controls driving of the stepping motor to change a rotational speed of the conveying roller to perform a document conveying speed control. Accordingly, an accuracy necessary for controlling a document conveying speed in accordance with document reading positions of the first and second reading sections can be secured.

Further, according to the present invention, the first reading section reads the one side of the document with a minification optical system image sensor, and the second reading section reads the other side of the document with a contact type optical system image sensor.

According to this invention, the first reading section used for the double-sided document reading is the minification optical system image sensor. Accordingly, if both sides of a document is read by the first reading section with front and back reversing, no difference in coloring occurs between read images on both sides of a document, and color images can be read in a high quality. Further, the second reading section for reading the other side of the document is the contact type optical system image sensor. Accordingly, the second reading section can be provided with a relatively small space without requiring a large space as compared to the case where the minification optical system image sensor is provided. Consequently, a document conveying passage for conveying a document again to the first reading section can be made small.

This application is based on Japanese Patent application serial No. 2007-252485 filed in Japan Patent Office on Sep. 27, 2007, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image reading apparatus, comprising:
a document feeding section which feeds a document;
a first reading section which reads one side of the document conveyed by the document feeding section;
a second reading section which is arranged on an upstream of the first reading section in a document conveying direction and reads other side of the document conveyed by the document feeding section;
a reversing section which reverses and conveys the document in such a manner that the other side of the document is to be read by the first reading section after the one side of the document is read by the first reading section; and
a controller which controls respective sections to perform a document reading operation in either one of a double-sided reverse-reading mode, in which the first reading section reads the other side of the document after the one side of the document is read by the first reading section and then the document is reversed by the reversing section, or a double-sided simultaneous-reading mode, in which the first reading section reads the one side of the document and the second reading section reads the second reading section reads the other side of the document at one document conveyance performed by the document feeding section, wherein
during the document reading operation in the double-sided reverse-reading mode, the controller allows the document feeding section to convey the document at a predetermined speed which is faster than a predetermined document reading speed at which the second reading section can read the document when the document passes through a document reading position of the second reading section, and the controller allows the document feeding section to convey the document at a predetermined document reading speed at which the first reading section can read the document when the document passes through a document reading position of the first reading section.

2. The image reading apparatus according to claim 1, wherein
during the document reading operation in the double-sided reverse-reading mode, the controller switches the document conveyance speed to be the predetermined speed which is faster than a predetermined document reading speed at which the second reading section can read the document after the document is reversed front and back by the reversing section, and the controller switches the document conveyance speed to be the predetermined document reading speed at which the first reading section can read the document when the document passes through the document reading position of the first reading section.

3. The image reading apparatus according to claim 1, wherein
during the document reading operation in the double-sided reverse-reading mode, the controller switches the document conveyance speed to be the predetermined speed which is faster than a predetermined document reading speed at which the second reading section can read the document when a rear end of the document passes through the document reading position of the first reading section, and the controller switches the document conveyance speed to be the predetermined document reading speed at which the first reading section can read the document when the document passes through the document reading position of the first reading section.

4. The image reading apparatus according to claim 1, wherein
the controller controls relevant sections including the first and second reading sections, the document feeding section, and the reversing section to perform the document reading operation in the double-sided reverse-reading mode, the double-sided simultaneous-reading mode, or a one-side reading mode in which the first reading section reads only the one side of the document, and
during the document reading operation in the one-side reading mode, the controller controls the document feeding section to convey the document at the predetermined speed which is faster than a predetermined document reading speed at which the second reading section can read the document when the document passes through the document reading position of the second reading section, and the controller controls the document feeding section to convey the document at the predetermined document reading speed at which the first reading section can read the document when the document passes through the document reading position of the first reading section.

5. The image reading apparatus according to claim 1, wherein
during the document reading operation in the double-sided simultaneous-reading mode, the controller controls the document feeding section to convey the document at the predetermined speed which is faster than a predetermined document reading speed at which the second reading section can read the document until the document arrives at the document reading position of the second reading section, and the controller controls the document feeding section to convey the document at the predetermined document reading speed at which the second reading section can read the document when the document comes to the document reading position of the second reading section.

6. The image reading apparatus according to claim 1, wherein
the document feeding section includes:
a conveying roller which conveys the document; and
a stepping motor as a drive power source which applies a rotational drive force to the conveying roller, wherein
the controller controls driving of the stepping motor to change a rotational speed of the conveying roller so as to control the document conveyance speed in accordance with the document reading positions of the first and second reading sections.

7. The image reading apparatus according to claim 1, wherein
the first reading section reads the one side of the document with a minification optical system image sensor, and
the second reading section reads the other side of the document with a contact type optical system image sensor.

8. An image forming apparatus, comprising:
a document feeding section which feeds a document;
a first reading section which reads one side of the document conveyed by the document feeding section;
a second reading section which is arranged on an upstream of the first reading section in a document conveying direction and reads other side of the document conveyed by the document feeding section;
a reversing section which reverses and conveys the document in such a manner that the other side of the document is to be read by the first reading section after the one side of the document is read by the first reading section;
a controller which controls respective sections to perform a document reading operation in either one of a double-sided reverse-reading mode, in which the first reading section reads the other side of the document after the one side of the document is read by the first reading section and then the document is reversed by the reversing section, or a double-sided simultaneous-reading mode, in which the first reading section reads the one side of the document and the second reading section reads the second reading section reads the other side of the document at one document conveyance performed by the document feeding section; and
an image forming section which forms an image on a recording sheet in accordance with data of a read image read by the first reading section and the second reading section, wherein
during the document reading operation in the double-sided reverse-reading mode, the controller allows the document feeding section to convey the document at a predetermined speed which is faster than a predetermined document reading speed at which the second reading section can read the document when the document passes through a document reading position of the second reading section, and the controller allows the document feeding section to convey the document at a predetermined document reading speed at which the first reading section can read the document when the document passes through a document reading position of the first reading section.

9. The image forming apparatus according to claim 8, wherein during the document reading operation in the double-sided reverse-reading mode, the controller switches the document conveyance speed to be the predetermined speed which is faster than the predetermined document reading speed at which the second reading section can read the document after the document is reversed front and back by the reversing section.

10. The image forming apparatus according to claim 8, wherein during the document reading operation in the double-sided reverse-reading mode, the controller switches the document conveyance speed to be the predetermined speed which is faster than the predetermined document reading speed at which the second reading section can read the document when a rear end of the document passes through the document reading position of the first reading section.

11. The image forming apparatus according to claim 8, wherein
the controller controls relevant sections including the first and second reading sections, the document feeding section, and the reversing section to perform the document reading operation in the double-sided reverse-reading mode, the double-sided simultaneous-reading mode, or a one-side reading mode in which the first reading section reads only the one side of the document, and
during the document reading operation in the one-side reading mode, the controller controls the document feeding section to convey the document at the predetermined speed which is faster than a predetermined document reading speed at which the second reading section can read the document when the document passes through the document reading position of the second reading section, and the controller controls the document feeding section to convey the document at the predetermined document reading speed at which the first reading section can read the document when the document passes through the document reading position of the first reading section.

12. The image forming apparatus according to claim 8, wherein
during the document reading operation in the double-sided simultaneous-reading mode, the controller controls the document feeding section to convey the document at the predetermined speed which is faster than a predetermined document reading speed at which the second reading section can read the document until the document arrives at the document reading position of the second reading section, and the controller controls the document feeding section to convey the document at the predetermined document reading speed at which the second reading section can read the document when the document comes to the document reading position of the second reading section.

13. The image forming apparatus according to claim 8, wherein
the document feeding section includes:
a conveying roller which conveys the document; and
a stepping motor as a drive power source which applies a rotational drive force to the conveying roller, wherein
the controller controls driving of the stepping motor to change a rotational speed of the conveying roller so as to control the document conveyance speed in accordance with the document reading positions of the first and second reading sections.

14. The image forming apparatus according to claim 8,
the first reading section reads the one side of the document with a minification optical system image sensor, and
the second reading section reads the other side of the document with a contact type optical system image sensor.
